(19) United States
(12) Patent Application Publication
(10) Pub. No.: US 2026/0092165 A1
(43) Pub. Date: Apr. 2, 2026

(54) SURFACE-TREATED SPHERICAL SILICA AND METHOD FOR PRODUCING SURFACE-TREATED SPHERICAL SILICA

(71) Applicants: AGC Inc., Tokyo (JP); AGC SI-TECH CO., LTD., Kitakyushu-shi (JP)

(72) Inventors: Hiromichi KAMO, Tokyo (JP); Shinnosuke ARIMITSU, Tokyo (JP)

(73) Assignees: AGC Inc., Tokyo (JP); AGC SI-TECH CO., LTD., Kitakyushu-shi (JP)

(21) Appl. No.: 19/411,472

(22) Filed: Dec. 8, 2025

Related U.S. Application Data
(63) Continuation of application No. PCT/JP2024/020733, filed on Jun. 6, 2024.

(30) Foreign Application Priority Data
Jun. 16, 2023 (JP) 2023-099442

(51) Int. Cl. C08K 9/06; C09C 1/30

(52) U.S. Cl. CPC C08K 9/06; C09C 1/3081; C01P 2004/32; C01P 2004/61; C01P 2004/62; C01P 2006/12; C01P 2006/40; C01P 2006/80

(57) ABSTRACT

Surface-treated spherical silica, having a median diameter d50 of 0.5 μm to 20 μm, a product A×d50 of a BET specific surface area A (m²/g) and the median diameter d50 (μm) being 2.7 (μm·m²/g) to 5.0 (μm·m²/g), a peak area of an amine in chromatography being 70% or more of a theoretical value, and a symmetry coefficient S of 8 or less in the chromatography.

### CROSS-REFERENCE TO RELATED APPLICATIONS

This is a continuation of International Application No. PCT/JP2024/020733 filed on Jun. 6, 2024, and claims priority from Japanese Patent Applications No. 2023-099442 filed on Jun. 16, 2023, the entire contents of which are incorporated herein by reference.

### TECHNICAL FIELD

The present invention relates to surface-treated spherical silica and a method for producing surface-treated spherical silica.

### BACKGROUND ART

An electrical insulation layer provided in a printed wiring board requires properties such as a low dielectric constant, a low dielectric loss tangent, and a low linear expansion coefficient. In recent years, resin compositions including a thermosetting resin and silica particles have been used to produce an electrical insulation layer provided in a metal clad laminate that can be processed into a printed wiring board (see Patent Literatures 1 and 2). Specifically, the metal clad laminate in which the semi-cured product of the above resin compositions is laminated as an electrical insulation layer on a surface of a metal substrate layer is used. As another example, a metal clad laminate in which glass cloth or the like impregnated with a resin composition is laminated as an electrical insulation layer on a surface of a metal substrate layer is used. Here, a filler (filling material) is used as a material of a prepreg using a thermosetting resin, and the filler itself typically tends to increase a relative dielectric constant of the obtained prepreg. Among these, a metal clad laminate using a hollow filler can lower the relative dielectric constant compared to that using a solid filler, and therefore is investigated as described in Patent Literatures 1 to 3.

Furthermore, when used in the resin composition, silica that has been surface-treated is used, and is investigated as described in Patent Literature 4.
Patent Literature 1: JP2008-31409A
Patent Literature 2: JP2017-522580A
Patent Literature 3: WO2019/230661
Patent Literature 4: JP6347644B

### SUMMARY OF INVENTION

The inventors have discovered that known surface-treated spherical silica in the related art does not provide sufficient adhesiveness between a resin composition, a semi-cured product thereof, a prepreg, or the like and a substrate made of a metal or the like. The inventors have discovered that if surface treatment conditions are not optimized, a silanol group remains on a silica surface, and peel strength after high-temperature and high-humidity test is significantly reduced.

Therefore, an object of the present invention is to provide surface-treated spherical silica in which excellent adhesiveness to a resin is exhibited when the surface-treated spherical silica is mixed with the resin for use in an electronic application, and the adhesiveness is not significantly reduced even when exposed to a high-temperature and high-humidity environment.

As a result of extensive research, the inventors have discovered that the above problem can be solved by setting a median diameter, a product of a BET specific surface area and the median diameter, a peak area of an amine in chromatography, and a symmetry coefficient S in chromatography of surface-treated spherical silica in specific ranges, leading to the completion of the present invention.

The present invention relates to the following.
(1) Surface-treated spherical silica, having a median diameter d50 of 0.5 μm to 20 μm, a product A×d50 of a BET specific surface area A (m²/g) and the median diameter d50 (μm) being 2.7 (μm·m²/g) to 5.0 (μm·m²/g), a peak area of an amine in chromatography being 70% or more of a theoretical value, and a symmetry coefficient S of 8 or less in the chromatography.
(2) The surface-treated spherical silica according to the (1), having the BET specific surface area of 0.1 m²/g to 3.5 m²/g.
(3) The surface-treated spherical silica according to the (1) or (2), having a Ti content of 30 ppm by mass to 1500 ppm by mass.
(4) A method for producing the surface-treated spherical silica according to any one of the (1) to (3), the method including: performing a surface treatment on untreated spherical silica, in which a value obtained by dividing a molecular weight of a silane coupling agent used in the surface treatment by the number of Si atoms contained in one molecule of the silane coupling agent is 100 to 300.
(5) The method for producing the surface-treated spherical silica according to the (4), in which the surface treatment includes bringing the untreated spherical silica into contact with the silane coupling agent, followed by heating at a temperature of 50° C. to 200° C.
(6) The method for producing the surface-treated spherical silica according to the (5), in which a solvent is used during the contact, and a solvent charged amount per gram of the untreated spherical silica is 0.1 ml/g to 1.0 ml/g.
(7) A resin composition including: the surface-treated spherical silica according to any one of the (1) to (3); and a resin.

The present invention can provide surface-treated spherical silica in which excellent adhesiveness to a resin is exhibited when the surface-treated spherical silica is mixed with the resin for use in an electronic application, and there is no significant change in adhesiveness even when exposed to harsh environments.

### DESCRIPTION OF EMBODIMENTS

Hereinafter, the present invention will be described, and the present invention is not limited by examples in the following description. Note that, in the present description, an expression “to” used to express a numerical range includes numerical values before and after it as a lower limit value and an upper limit value of the range, respectively.

### <Surface-Treated Spherical Silica>

In surface-treated spherical silica of the present invention, a median diameter d50 of the surface-treated spherical silica is 0.5 μm to 20 μm, a product A×d50 of a BET specific surface area A (m²/g) and the median diameter d50 (μm) is 2.7 (μm·m²/g) to 5.0 (μm·m²/g), a peak area of an amine in chromatography is 70% or more of a theoretical value, and a symmetry coefficient S is 8 or less in chromatography.

Generally, silanol groups (Si—OH) of silica particles are classified into an internal silanol group present within an Si—O network inside the particle, an isolated silanol group which is a silanol group present on a particle surface and not bonded to water adsorbed to the silica particle, and a bonded silanol group bonded to water adsorbed to the silica particle or bonded to silanol on a silica surface. When a surface treatment is performed on the silica particle, these silanol groups react with a surface treatment agent and are substituted with substituents that make silica surfaces more compatible with a resin. In this case, it is found that if raw materials used for the surface treatment and treatment conditions are not properly adjusted, adhesiveness to the resin decreases, and in addition, the adhesiveness to the resin decreases significantly after a high-temperature and high-humidity test.

Therefore, in the surface-treated spherical silica of the present invention, the median diameter d50 of the surface-treated spherical silica is 0.5 μm to 20 μm, the product A×d50 of the BET specific surface area A (m²/g) and the median diameter d50 (μm) is 2.7 (μm·m²/g) to 5.0 (μm·m²/g), the peak area of an amine in chromatography is 70% or more of the theoretical value, and the symmetry coefficient S is 8 or less in chromatography. When the median diameter d50 is 0.5 μm to 20 μm, the product A×d50 of the BET specific surface area A (m²/g) and the median diameter d50 (μm) is 2.7 (μm·m²/g) to 5.0 (μm·m²/g), the peak area is 70% or more of the theoretical value, and the symmetry coefficient S is 8 or less, it is considered that a surface area relative to a particle size is controlled to be sufficiently small, silanol groups on silica particle surfaces are sufficiently reduced, and the silanol groups on the surfaces sufficiently react with a silane coupling agent, and silica surfaces are sufficiently covered with the silane coupling agent. Therefore, excellent peel strength is obtained, and the silanol group that interacts with an amine is sufficiently deactivated, and the silanol group that interacts with a water molecule when exposed to high-temperature and high-humidity conditions is also deactivated, and thus reduction in peel strength after high-temperature and high-humidity test is prevented. Here, the deactivation refers to a state in which the silanol group reacts with the silane coupling agent and is less likely to interact with the amine.

When the median diameter d50, which is a particle diameter at a point on a volume-based particle size distribution curve where a cumulative volume from a smallest particle size reaches 50%, is in a range of 0.5 μm or more, the surface area can be appropriately controlled, and the silanol groups can be appropriately reduced. Further, an increase in the viscosity of the resin composition obtained by dispersing the surface-treated spherical silica in the resin can be prevented, and a deterioration in the dispersibility of the surface-treated spherical silica in the resin can be prevented. In addition, in the case where the median diameter d50 exceeds 20 μm, when a resin composition including the spherical silica is formed into, for example, a sheet, a minimum thickness of the sheet becomes thick, which may cause granulation. Accordingly, in the present invention, the median diameter d50 of the spherical silica is in the range of 0.5 μm to 20 μm. The median diameter d50 is preferably 0.5 μm to 15 μm, more preferably 0.5 μm to 10 μm, still more preferably 1.0 μm to 5.0 μm, and particularly preferably 1.5 μm to 5.0 μm.

The d50 is a volume-based cumulative 50% diameter obtained by a laser diffraction particle size distribution analyzer (for example, “MT3300EXII” manufactured by MicrotracBEL Corp.). That is, the particle size distribution is measured by a laser diffraction and scattering method, a cumulative curve is obtained from the smallest value by setting a total volume of the surface-treated spherical silica to 100%, and the volume-based cumulative 50% diameter represents a particle diameter at a point on the cumulative curve where the cumulative volume reaches 50%.

A theoretical value of the product A×d50 of the BET specific surface area A (m²/g) and the median diameter d50 (μm) is 2.7 (μm·m²/g) [derived from specific surface area-6/(silica true density 2.2 (g/cm³)×median diameter d50 (μm))], and values below the theoretical value are practically unattainable. The larger the value of A×d50, the smaller the specific surface area per particle size, and the fewer silanol groups present on the silica particle surface, which can prevent a decrease in peel strength after high-temperature and high-humidity test. The product A×d50 is preferably 5.0 or less, more preferably 4.5 or less, and most preferably 4.0 or less.

Since a theoretical value of the peak area of an amine in chromatography is 100%, it is theoretically impossible for the peak area to exceed 100%. The peak area is 70% or more of the theoretical value, preferably 80% or more, more preferably 90% or more, and most preferably 95% or more.

Since a theoretical value of the symmetry coefficient S is at least 1, it is theoretically impossible for the symmetry coefficient S to be less than 1. The symmetry coefficient S is 8 or less, preferably 3 or less, more preferably 2.5 or less, still more preferably 2 or less, and most preferably 1.5 or less.

A method for measuring the above symmetry coefficient and peak area of an amine in chromatography is as follows.

The surface-treated spherical silica is wet-packed into a stainless steel column with an internal diameter of 4.6 mm and a length of 100 mm, and this column is then loaded into a chromatography device (Prominence (manufactured by Shimadzu Corporation)), and measurement is performed under the following conditions.
Eluent: MeOH/20 mM buffer solution of phosphoric acid (pH 7.0)=82/18
Flow rate: 0.5 mL/min
Temperature: 25° C.
Detector: UV at 254 nm
Sample: propranolol hydrochloride

An obtained peak is analyzed according to JIS K0124:2011 to obtain the peak area and the symmetry coefficient. Note that a peak area obtained when the same measurement is performed without packing the surface-treated spherical silica is used as the theoretical value of the peak area.

The symmetry coefficient S and the peak area of an amine in chromatography of the surface-treated spherical silica can be adjusted by a type and an amount of the surface treatment agent, an amount of the solvent used during the surface treatment, a surface treatment temperature, and the like.

It is preferable that the surface-treated spherical silica of the present invention is spherical and has an average circularity of 0.90 or more. When the average circularity is 0.90 or more, the particles are substantially spherical, so that the specific surface area of the particles can be reduced, and active surfaces are not exposed because protrusions are not chipped by vibration of the particles, so that the silica particles can have a low dielectric constant. The average circularity is more preferably 0.92 or more, particularly preferably 0.95 or more, and most preferably 1.00 since the closer to a perfect sphere the more desirable it is.

A circularity can be determined by photographing a particle with a scanning electron microscope (for example, JCM-7000 manufactured by JEOL Ltd.), determining an area and a perimeter of the particle using image analysis software, for example, image analysis software attached to a particle image analyzer (for example, Morphologi4 manufactured by Malvern Panalytical Ltd), and applying the results to the following formula for calculation. Note that the average value determined from circularity of 20 particles is taken as an average circularity.

Circularity=perimeter of circle with equal projected area/perimeter of particle
Perimeter of circle with equal projected area: observing a particle from directly above, obtaining an area of a shadow of the particle reflected on a plane below, and calculating a circle having an area equal to this area, so as to obtain a length of an outline of the circle
Perimeter of particle: observing the particle from directly above to obtain a length of an outline of the shadow of the particle reflected on the plane below

The surface-treated spherical silica of the present invention preferably has the BET specific surface area of 0.1 m²/g to 3.5 m²/g. It is substantially difficult to set the BET specific surface area to less than 0.1 m²/g. When the BET specific surface area is 3.5 m²/g or less, it is possible to prevent an increase in the viscosity when the surface-treated spherical silica is dispersed in a resin to form a resin composition, and the dispersibility in the resin composition is not deteriorated. The BET specific surface area is preferably 0.1 m²/g to 3.5 m²/g, more preferably 0.2 m²/g to 3.0 m²/g, still more preferably 0.5 m²/g to 3.0 m²/g, and particularly preferably 0.8 m²/g to 2.8 m²/g.

The specific surface area is obtained by a multi-point BET method based on a nitrogen adsorption method using the specific surface area and pore distribution measuring device (for example, “BELSORP-mini II” manufactured by MicrotracBEL Corp., or “TriStar II” manufactured by Micromeritics Instrument Corporation).

The surface-treated spherical silica of the present invention is surface-treated with a silane coupling agent. By surface-treating with a silane coupling agent, which is a surface treatment agent, a strong bond is formed between a functional group of the silane coupling agent and the silanol group, and this bond is not broken when the surface-treated spherical silica is mixed with a resin. The bond is not easily broken by moisture even in a high-temperature and high-humidity environment. Furthermore, by bonding an organic functional group of the silane coupling agent to the silica surface, an amount of silanol groups remained on the surface is reduced, the surface is made hydrophobic, and the affinity with the resin in the resin composition is improved, the dispersibility of the surface-treated spherical silica in the resin and the strength after forming a resin film can be improved, and moisture adsorption can be inhibited to improve a decrease in the peel strength after high-temperature and high-humidity test.

Examples of types of the silane coupling agent include an aminosilane coupling agent, an allylsilane coupling agent, an epoxysilane coupling agent, a mercaptosilane coupling agent, an alkylsilane coupling agent, a fluorine-containing silane coupling agent, and an organosilazane compound. One type of the silane coupling agent may be used or two or more types thereof may be used in combination.

Specifically, examples of the silane coupling agent include an aminosilane coupling agent such as aminopropylmethoxysilane, aminopropyltriethoxysilane, ureidopropyltriethoxysilane, N-phenylaminopropyltrimethoxysilane, and N-(2-aminoethyl)aminopropyltrimethoxysilane; an allylsilane coupling agent such as methyltrimethoxysilane, vinyltrimethoxysilane, octadecyltrimethoxysilane, phenyltrimethoxysilane, metachloroxypropyltrimethoxysilane, imidazole silane, and triazine silane; an epoxysilane coupling agent such as glycidoxypropyltrimethoxysilane, glycidoxypropyltriethoxysilane, glycidoxypropylmethyldiethoxysilane, glycidylbutyltrimethoxysilane, and (3,4-epoxycyclohexyl)ethyltrimethoxysilane; a mercaptosilane coupling agent such as mercaptopropyltrimethoxysilane and mercaptopropyltriethoxysilane; an alkylsilane coupling agent such as methyltrimethoxysilane, ethyltrimethoxysilane, hexyltrimethoxysilane, octyltrimethoxysilane, decyltrimethoxysilanc, octadecyltrimethoxysilane, dimethyldimethoxysilane, and octyltriethoxysilane; a fluorine-containing silane coupling agent such as CF₃(CF₂)₇CH₂CH₂Si(OCH₃)₃, CF₃(CF₂)₇CH₂CH₂SiCl₃, CF₃(CF₂)₇CH₂CH₂Si(CH₃)(OCH₃)₂, CF₃(CF₂)₇CH₂CH₂Si(CH₃)Cl₂, CF₃(CF₂)₅CH₂CH₂SiCl₃, CF₃(CF₂)₅CH₂CH₂Si(OCH₃)₃, CF₃CH₂CH₂SiCl₃, CF₃CH₂CH₂Si(OCH₃)₃, C₈F₁₇SO₂N(C₃H₇)CH₂CH₂CH₂Si(OCH₃)₃, C₇F₁₅CONHCH₂CH₂CH₂Si(OCH₃)₃, C₈F₁₇CO₂CH₂CH₂CH₂Si(OCH₃)₃, C₈F₁₇—O—CF(CF₃)CF₂—O—C₃H₆SiCl, and C₃F₇—O—(CF(CF₃)CF₂—O)₂—CF(CF₃)CONH—(CH₂)₃Si(OCH₃)₃; and an organosilazane compounds such as hexamethyldisilazane, hexaphenyldisilazane, trisilazane, cyclotrisilazane, and 1,1,3,3,5,5-hexamethylcyclotrisilazane.

A treatment amount of the silane coupling agent is preferably 0.01 parts by mass or more, more preferably 0.02 parts by mass or more, and still more preferably 0.10 parts by mass or more, and is preferably 5 parts by mass or less, and more preferably 2 parts by mass or less with respect to 100 parts by mass of the spherical silica. When two or more types of the silane coupling agents are used in combination, the above treatment amount means a total treatment amount of the plurality of types of the silane coupling agents.

Examples of the method for treating with the silane coupling agent include a dry method in which the silane coupling agent is sprayed onto spherical silica 1 that is one before the surface treatment, and a wet method in which the spherical silica 1 is dispersed in a solvent and then a silane coupling agent is added to react with the spherical silica. (Here, the “spherical silica 1” refers to untreated spherical silica before the surface treatment.)

Note that the fact that the surface of the surface-treated spherical silica is treated with the silane coupling agent can be confirmed by detecting a peak due to a substituent of the silane coupling agent using IR. An adhesion amount of the silane coupling agent can be measured by an amount of carbon. The amount of carbon can be measured by a combustion method using a SUMIGRAPH NC-80 (manufactured by Sumika Chemical Analysis Service, Ltd.).

From a viewpoint of performing a uniform treatment, a wet treatment method is preferable as a surface treatment condition. A solvent used in this case may be a hydrocarbon organic solvent.

A value obtained by dividing a molecular weight of the silane coupling agent by the number of Si atoms contained in one molecule of the silane coupling agent is preferably 100 or more and 300 or less. The value corresponds to a molecular weight of a group to be bonded when the silane coupling agent is bonded to the silica particle surface. When the value is 100 or more, the volatility of the silane coupling agent can be reduced to prevent the silane coupling agent from evaporating during the reaction. When the value is 300 or less, steric hindrance is created to prevent the silanol group from remaining.

The value is preferably 100 or more, more preferably 150 or more, and still more preferably 180 or more. In addition, the value is preferably 300 or less, more preferably 270 or less, and still more preferably 260 or less.

When two or more types of the silane coupling agents are used in combination, the above value for each of the silane coupling agents is preferably 100 or more and 300 or less.

Furthermore, in the surface treatment, a heating temperature after bringing the spherical silica 1 into contact with the silane coupling agent is preferably 50° C. to 200° C. When the heating temperature is high, a remaining percentage of the silane coupling agent is increased, and when the heating temperature is too high, partial decomposition begins, resulting in the regeneration of silanol groups. When the heating temperature is low, a reaction rate is reduced, the silanol groups are more likely to remain, and the peel strength of the resin, particularly after a high-temperature and high-humidity test, deteriorates. The heating temperature is more preferably 60° C. or higher, still more preferably 70° C. or higher, and most preferably 80° C. or higher. The heating temperature is more preferably 170° C. or lower.

In the surface treatment, a solvent charged amount per gram of the spherical silica is preferably 0.1 ml/g to 1.0 ml/g. When the solvent charged amount per gram of the spherical silica is 0.1 ml/g or more, a solvent amount enough to sufficiently cover a surface of the spherical silica 1 is ensured, and thus the silanol group is difficult to remain, and a decrease in the peel strength, particularly after the high-temperature and high-humidity test, can be prevented. When the solvent charged amount is 1.0 ml/g or less, a solvent amount to be distilled off is reduced, resulting in excellent productivity.

The solvent charged amount is preferably 0.1 ml/g or more, more preferably 0.2 ml/g or more, and most preferably 0.3 ml/g or more. In addition, the solvent charged amount is preferably 1.0 ml/g or less, more preferably 0.8 ml/g or less, and most preferably 0.6 ml/g or less.

The surface-treated spherical silica of the present invention preferably contains titanium (Ti) in a range of 30 ppm by mass to 1500 ppm by mass. A Ti content Ti is more preferably 80 ppm by mass or more and still more preferably 100 ppm by mass or more, and is more preferably 1000 ppm by mass or less, and still more preferably 500 ppm by mass or less. The Ti content can be measured by inductively coupled plasma (ICP) emission spectrometry after adding perchloric acid and hydrofluoric acid to the silica, igniting the mixture, and removing silicon which is the main component.

Ti is a component that is optionally included in the production of the surface-treated spherical silica. In the production of the surface-treated spherical silica, if fine powder is generated due to cracking of silica particles, the fine powder adheres to a surface of a base particle, and a specific surface area of the particle is increased. By including Ti at the time of producing the surface-treated spherical silica, it is easy to perform densification during firing. Accordingly, it is difficult to crack during post-processing after firing, and thus, generation of the fine powder can be prevented, and the number of adhesive particles adhering to the surface of the silica base particles can be reduced, thereby preventing an increase in the specific surface area. By including 30 ppm by mass or more of Ti, it is easy to perform densification during firing, and thus, the generation of the fine powder due to cracking can be reduced, and in the case where a Ti content is less than or equal to 1500 ppm by mass, the above-described effect can be obtained, an increase in the amount of the silanol group can be prevented and deterioration of the dielectric loss tangent can be prevented.

The surface-treated spherical silica of the present invention may include an impurity element other than titanium (Ti) as long as the effect of the present invention is not impaired. Examples of the impurity element include Na, K, Mg, Ca, Al, and Fe in addition to Ti.

A content of an alkali metal and an alkaline earth metal in the impurity element is preferably 2000 ppm by mass or less, more preferably 1000 ppm by mass or less, and still more preferably 200 ppm by mass or less in total. The content is preferably 1 ppm by mass or more, more preferably 2 ppm by mass or more, and still more preferably 5 ppm by mass or more in total.

### <Spherical Silica 1>

The spherical silica 1, that is, the untreated spherical silica before surface treatment, can be obtained by a known production method in the related art. Examples of the production method include a dry method and a wet method. In addition, commercially available spherical silica 1 may be used. The spherical silica 1 may be selected appropriately depending on the properties desired for the surface-treated spherical silica.

The BET specific surface area and the median diameter d50 of the spherical silica 1 generally correspond to the BET specific surface area and the median diameter d50 of the surface-treated spherical silica. Therefore, the characteristics of the spherical silica 1 may be selected appropriately based on the characteristics desired for the surface-treated spherical silica.

### <Resin Composition>

The surface-treated spherical silica of the present invention has excellent adhesiveness to the resin, and thus mixability with the resin composition is excellent.

The resin composition according to the present embodiment includes the surface-treated spherical silica of the present invention and the resin. A content of the surface-treated spherical silica relative to 100 parts by mass of the resin is preferably 10 parts by mass to 400 parts by mass, more preferably 50 parts by mass to 300 parts by mass, and still more preferably 70 parts by mass to 250 parts by mass. In particular, when the silica particles are preferably highly packed, the content of the silica particles is preferably 80 parts by mass or more, and more preferably 90 parts by mass or more. When the content of the surface-treated spherical silica is 10 parts by mass or more, a sufficient reduction in dielectric constant can be obtained, and when the content is 400 parts by mass or less, adhesiveness between the resin composition and a metal substrate is maintained.

The resin may use one or two or more types of a polyamide resin such as an epoxy resin, a silicone resin, a phenol resin, a melamine resin, a urea resin, an unsaturated polyester resin, a fluororesin, a polyimide resin, a polyamide-imide resin, or a polyether imide; a polyester resin such as a polybutylene terephthalate or a polyethylene terephthalate; a polyphenylene ether resin, a polyphenylene sulfide resin, an ortho-divinyl benzene resin, an aromatic polyester resin, a polysulfone, a liquid crystal polymer, a polyethersulfone, a polycarbonate, a maleic imide modified resin, an acrylonitrile butadiene styrene (ABS) resin, an acrylonitrile-acrylic rubber-styrene (AAS) resin, an acrylonitrile-ethylene-propylene-diene rubber-styrene (AES) resin, a poly tetrafluoroethylene (PTFE), a tetrafluoroethylene-perfluoroalkyl vinyl ether copolymer (PFA), a tetrafluoroethylene-hexafluoropropylene copolymer (FEP), and a tetrafluoroethylene-ethylene copolymer (ETFE). Since the dielectric loss tangent in the resin composition also depends on characteristics of the resin, the resin to be used may be selected in consideration of this factor.

The resin preferably includes a thermosetting resin. The thermosetting resins may be used alone or in combination. Examples of the thermosetting resin include an epoxy resin, a polyphenylene ether resin, a polyimide resin, a phenol resin, and an ortho-divinyl benzene resin. From viewpoints of adhesiveness, heat resistance, and the like, the thermosetting resin is preferably an epoxy resin, a polyphenylene ether resin, or an ortho-divinyl benzene resin.

From viewpoints of adhesiveness, dielectric characteristics, and the like, a weight average molecular weight of the thermosetting resin is preferably 1000 to 7000, more preferably 1000 to 5000, and still more preferably 1000 to 3000. The weight average molecular weight is determined by gel permeation chromatography (GPC) in terms of polystyrene.

A particle size distribution of the surface-treated spherical silica contained in the resin composition is preferably unimodal. The fact that the particle size distribution of the surface-treated spherical silica is unimodal can be confirmed from a matter that there is one peak in the particle size distribution according to a laser diffraction and scattering method.

The resin composition may contain an optional component other than the above resin and medium (for example, toluene, methyl ethyl ketone, methyl isobutyl ketone, and cyclohexanone). Examples of the optional component include a dispersion aid, a surfactant, and a filler other than silica particles.

### EXAMPLES

Hereinafter, the present invention will be described with reference to Examples, but the present invention is not limited thereto. In the following description, common components employ the same substance.

### Test Example 1

### (Spherical Silica A)

Silica 1 (H-31, d50-3.5 μm, manufactured by AGC Si-Tech Co., Ltd.) produced by a wet method was used as a spherical silica precursor. A content of titanium (Ti) in the silica 1 was measured to be 300 ppm by mass. An alumina crucible was filled with 15 g of the silica 1, followed by heat-treating in an electric furnace with a temperature of 1300° C. for 1 hour. After the heat treatment, the mixture was cooled to room temperature and passed through a vibrating sieve with an opening of 150 μm to obtain spherical silica A.

### (Spherical Silica B)

Except that silica 2 (H-51, d50=5.5 μm, produced by AGC Si-Tech Co., Ltd.) produced by a wet method was used as the spherical silica precursor, the spherical silica B was obtained in the same manner as the spherical silica A. A content of Ti in the silica 2 used as the spherical silica precursor was measured to be 300 ppm by mass.

### (Spherical Silica C)

Except that silica 3 (H-121, d50=13 μm, produced by AGC Si-Tech Co., Ltd.) produced by a wet method was used as the spherical silica precursor, the spherical silica was obtained in the same manner as the spherical silica A. A content of Ti in the silica 3 used as the spherical silica precursor was measured to be 300 ppm by mass.

### (Spherical Silica D)

Except that silica 4 (H-201, d50=20 μm, produced by AGC Si-Tech Co., Ltd.) produced by a wet method was used as the spherical silica precursor, the spherical silica D was obtained in the same manner as the spherical silica A. A content of Ti in the silica 4 used as the spherical silica precursor was measured to be 300 ppm by mass.

### (Spherical Silica E)

Except that silica 6 (H-51, d50=5.5 μm, produced by AGC Si-Tech Co., Ltd.) produced by a wet method was used as the spherical silica precursor, the spherical silica E was obtained in the same manner as the spherical silica A. A content of Ti in the silica 6 used as the spherical silica precursor was measured to be 1450 ppm by mass.

### (Spherical Silica F)

Except that silica 7 (H-51, d50=5.5 μm, produced by AGC Si-Tech Co., Ltd.) produced by a wet method was used as the spherical silica precursor, the spherical silica F was obtained in the same manner as the spherical silica A. A content of Ti in the silica 7 used as the spherical silica precursor was measured to be 35 ppm by mass.

### (Spherical Silica G)

The silica 1 (H-31, d50=3.5 μm, manufactured by AGC Si-Tech Co., Ltd.) produced by a wet method was used as a spherical silica precursor. A content of Ti in the silica 1 was measured to be 300 ppm. An alumina crucible was filled with 15 g of the silica 1, followed by heat-treating in an electric furnace with a temperature of 1050° C. for 6 hours. After the heat treatment, the mixture was cooled to room temperature and passed through a vibrating sieve with an opening of 150 μm to obtain spherical silica G.

### (Surface Treatment)

In a 3.5 L planetary mixer (HIVIS MIX 3L-5, manufactured by PRIMIX Corporation), 2000 g of spherical silica particles was placed. In addition, 3.0 g of a silane coupling agent listed in Table 1 was added to hexane, which was adjusted such that the solvent charged amount per gram of the spherical silica was a value in Table 1, followed by stirring for 5 minutes with a magnetic stirrer to prepare a solution. The prepared solution was added in the planetary mixer containing the spherical silica, and nitrogen was introduced for 10 minutes while stirring at 60 rpm. A temperature was increased to 80° C. at a rate of 2° C./min while nitrogen was introduced and maintained at 80° C. for 1 hour, and then the mixture was allowed to cool to 50° C. and removed into the air to obtain surface-treated spherical silica. According to this procedure, the surface-treated spherical silica according to Examples 2 to 12 and 18 to 25 was obtained. In Example 1, the spherical silica A was used as is without surface treatment.

In Examples 13 to 17, except that the heating temperature was changed from 80° C. to temperatures listed in Table 1, surface-treated spherical silica was prepared in the same manner as in Example 1.

The surface-treated spherical silica was prepared in the same manner as in Example 1, except that the usage amount in Example 26 was changed to 0.5 g of the silane coupling agent listed in Table 1, in Example 27 was changed to 1.0 g of the silane coupling agent listed in Table 1, in Example 28 was changed to 12.0 g of the silane coupling agent listed in Table 1, and in Example 29 was changed to 30.0 g of the silane coupling agent listed in Table 1.

Hereinafter, the spherical silica in Example 1 and the surface-treated spherical silica in Examples 2 to 29 may be collectively referred to as the “spherical silica”.

The following measurements were conducted on the obtained spherical silica according to Examples 1 to 29. The results are shown in Table 1.

### (Measurement by Chromatography)

Regarding the spherical silica according to each of Examples, a symmetry coefficient and a peak area of an amine in chromatography were measured by the following method, and results were shown in Table 1.

The spherical silica was wet-packed into a stainless steel column with an internal diameter of 4.6 mm and a length of 100 mm, and this column was then loaded into a chromatography device (Prominence (manufactured by Shimadzu Corporation)) and was measured under the following conditions.
Eluent: MeOH/20 mM buffer solution of phosphoric acid (pH 7.0)=82/18
Flow rate: 0.5 mL/min
Temperature: 25° C.
Detector: UV at 254 nm
Sample: propranolol hydrochloride

An obtained peak was analyzed according to JIS K0124:2011 to obtain the peak area and the symmetry coefficient. Note that a peak area obtained when the same measurement was performed without packing the spherical silica was used as the theoretical value of the peak area. In Table 1, “-” in the symmetry coefficient S indicated that the amine was adsorbed to the spherical silica and could not be detected.

### (Method for Measuring BET Specific Surface Area of Spherical Silica)

The spherical silica used in each of Examples was dried under reduced pressure at 230° C. to completely remove water, thereby obtaining a sample. Regarding this sample, the specific surface area was obtained by a multi-point BET method using a nitrogen gas in “TriStar II”, which is an automatic specific surface area and pore distribution measuring device manufactured by Micromeritics Instrument Corporation. The results are shown in Table 1.

### (Method for Measuring d50 of Spherical Silica)

The d50 of the spherical silica used in each of Examples was measured by a particle size distribution analyzer (MT3300EXII manufactured by MicrotracBEL Corp.) using a laser diffraction and scattering method. Specifically, the measurement was performed after dispersing secondary particles of the spherical silica by being irradiated with ultrasonic waves for 120 seconds, and the value at which the cumulative distribution of the obtained particle sizes reached 50% was defined as d50. The results are shown in Table 1. Table 1 also shows the product (μm·m²/g) of the BET specific surface area (m²/g) and the median diameter (μm).

### (Measurement of Peel Strength of Resin Composition Using Spherical Silica)

### Example 1

In a planetary centrifugal mixer (Awatori Rentaro ARE-310, manufactured by Thinky Corporation), 25 parts by mass of polyphenylene ether resin, 50 parts by mass of butadiene-styrene random copolymer, 0.75 parts by mass of α,α′-di(t-butylperoxy)diisopropylbenzene, 225 parts by mass of spherical silica A, and 50 parts by mass of toluene were placed, followed by mixing at 2000 rpm for 30 minutes to obtain a resin composition.

The obtained resin composition was vacuum dried at 120° C. for 1 hour, and then 5 g of the mixture was sampled and placed in a 80 mm square mold having a thickness of 0.3 mm, and low-profile copper foil (thickness: 18 μm, Rz: 3.5 μm, manufactured by Mitsui Kinzoku Co., Ltd., 3EC-M3-V-18) was laminated on top and bottom. A temperature of the obtained laminate was increased to 200° C. at a temperature increase rate of 5° C./min and maintained for 120 minutes at a pressure of 10 MPa for heat molding to obtain a resin-coated metal substrate. Regarding the obtained resin-coated metal substrate, peel strength between a cured product of a prepreg and the copper foil was measured in accordance with IPC-TM650-2.4.8. The peel strength is described as “peel (PPE)” in Table 1.

The peel strength after a high temperature and high humidity test was measured in the same manner after leaving the obtained resin-coated metal substrate in a constant temperature and humidity chamber set at 85° C. and 85% RH for 24 hours. In Table 1, the peel strength after high-temperature and high-humidity test was described as “high-temperature and high-humidity peel”.

The obtained resin-coated metal substrate was etched with an etching solution (H-1000A, manufactured by Sunhayato Corp.) and dried in an oven at 100° C. for 1 hour, and then a split-post dielectric resonator (SPDR) (manufactured by Agilent Technologies) was used to measure the relative dielectric constant and the dielectric loss tangent.

The obtained measurement results were summarized in Table 1.

### Examples 2 to 29

Except that the spherical silica A was changed to the surface-treated spherical silica shown in Table 1, the resin composition, the prepreg, and the resin-coated metal substrate were produced in the same manner as in Example 1, and measurements similar to those in Example 1 were carried out.

TABLE 1

| | Spherical silica | | | | | | High- | |
|---|---|---|---|---|---|---|---|---|
| | | Specific | | | | | temperature | |
| | | surface | Median | | | Peel | and high- | Symmetry |
| | | area | diameter | Product | Ti | (PPE) | humidity peel | coefficient |
| | Type | m²/g | μm | μm · m²/g | ppm | N/cm | N/cm | S |
| Example 1 | A | 1.3 | 3 | 3.9 | 300 | 2 | 0.5 | — |
| Example 2 | A | 1.3 | 3 | 3.9 | 300 | 4 | 1 | 10 |
| Example 3 | A | 1.3 | 3 | 3.9 | 300 | 8 | 6 | 1.03 |
| Example 4 | B | 0.6 | 5 | 3.0 | 300 | 9 | 7 | 1.04 |
| Example 5 | C | 0.4 | 8 | 3.2 | 300 | 9 | 7 | 1.02 |
| Example 6 | D | 0.2 | 18 | 3.6 | 300 | 9 | 7 | 1.01 |
| Example 7 | E | 0.8 | 5 | 4.0 | 1450 | 9 | 6 | 1.1 |
| Example 8 | F | 0.9 | 4 | 3.6 | 35 | 8 | 6 | 1.15 |
| Example 9 | G | 1.6 | 3 | 4.8 | 300 | 7 | 5 | 1.34 |
| Example 10 | A | 1.3 | 3 | 3.9 | 300 | 6 | 2 | 3 |
| Example 11 | A | 1.3 | 3 | 3.9 | 300 | 8 | 7 | 1.02 |
| Example 12 | A | 1.3 | 3 | 3.9 | 300 | 8 | 7 | 1.02 |
| Example 13 | A | 1.3 | 3 | 3.9 | 300 | 8 | 7 | 1.05 |
| Example 14 | A | 1.3 | 3 | 3.9 | 300 | 8 | 7 | 1.05 |
| Example 15 | A | 1.3 | 3 | 3.9 | 300 | 7 | 6 | 1.2 |
| Example 16 | A | 1.3 | 3 | 3.9 | 300 | 7 | 5 | 1.3 |
| Example 17 | A | 1.3 | 3 | 3.9 | 300 | 6 | 4 | 2 |
| Example 18 | A | 1.3 | 3 | 3.9 | 300 | 6 | 3 | 1.3 |
| Example 19 | A | 1.3 | 3 | 3.9 | 300 | 6 | 6 | 1.15 |
| Example 20 | A | 1.3 | 3 | 3.9 | 300 | 6 | 5 | 1.1 |
| Example 21 | A | 1.3 | 3 | 3.9 | 300 | 7 | 6 | 1.12 |
| Example 22 | A | 1.3 | 3 | 3.9 | 300 | 7 | 6 | 1.07 |
| Example 23 | A | 1.3 | 3 | 3.9 | 300 | 7 | 6 | 1.06 |
| Example 24 | A | 1.3 | 3 | 3.9 | 300 | 8 | 7 | 1.1 |
| Example 25 | A | 1.3 | 3 | 3.9 | 300 | 7 | 5 | 1.8 |
| Example 26 | A | 1.3 | 3 | 3.9 | 300 | 6 | 3 | 1.03 |
| Example 27 | A | 1.3 | 3 | 3.9 | 300 | 8 | 6 | 1.03 |
| Example 28 | A | 1.3 | 3 | 3.9 | 300 | 8 | 6 | 1.03 |
| Example 29 | A | 1.3 | 3 | 3.9 | 300 | 8 | 5 | 1.03 |

| | | Surface treatment | | | |
|---|---|---|---|---|---|
| | | | Molecular | Solvent charged | Heating |
| | Peak | | weight/number | amount per gram | temperature |
| | area | Coupling agent | of Si | ml/g | ° C. |
| Example 1 | 0% | | | | |
| Example 2 | 50% | Vinyltrimethoxysilane | 190.3 | 0.05 | 80 |
| Example 3 | 100% | Vinyltrimethoxysilane | 190.3 | 0.5 | 80 |
| Example 4 | 100% | Vinyltrimethoxysilane | 190.3 | 0.5 | 80 |
| Example 5 | 100% | Vinyltrimethoxysilane | 190.3 | 0.5 | 80 |
| Example 6 | 100% | Vinyltrimethoxysilane | 190.3 | 0.5 | 80 |
| Example 7 | 100% | Vinyltrimethoxysilane | 190.3 | 0.5 | 80 |
| Example 8 | 100% | Vinyltrimethoxysilane | 190.3 | 0.5 | 80 |
| Example 9 | 95% | Vinyltrimethoxysilane | 190.3 | 0.5 | 80 |
| Example 10 | 70% | Vinyltrimethoxysilane | 190.3 | 0.1 | 80 |
| Example 11 | 100% | Vinyltrimethoxysilane | 190.3 | 0.8 | 80 |
| Example 12 | 100% | Vinyltrimethoxy silane | 190.3 | 1 | 80 |
| Example 13 | 100% | Vinyltrimethoxysilane | 190.3 | 0.5 | 120 |
| Example 14 | 100% | Vinyltrimethoxysilane | 190.3 | 0.5 | 170 |
| Example 15 | 97% | Vinyltrimethoxysilane | 190.3 | 0.5 | 250 |
| Example 16 | 95% | Vinyltrimethoxysilane | 190.3 | 0.5 | 60 |
| Example 17 | 82% | Vinyltrimethoxysilane | 190.3 | 0.5 | 30 |
| Example 18 | 95% | 1,1,1,3,3,3-Hexamethyldisilazane | 80.7 | 0.5 | 80 |
| Example 19 | 100% | Octyltrimethoxysilane | 234.41 | 0.5 | 80 |
| Example 20 | 100% | Propyltrimethoxysilane | 164.28 | 0.5 | 80 |
| Example 21 | 100% | N-phenyl-3-aminopropyltrimethoxysilane | 255.4 | 0.5 | 80 |
| Example 22 | 100% | Vinyltrimethoxysilane/N-phenyl-3- | 190.3/255.4 | 0.5 | 80 |
| | | aminopropyltrimethoxysilane | | | |
| Example 23 | 100% | 3-Aminopropyltrimethoxysilane/N- | 179.29/255.4 | 0.5 | 80 |
| | | phenyl-3-aminopropyltrimethoxysilane | | | |
| Example 24 | 100% | 3-Methacryloxypropyltrimethoxysilane | 248.4 | 0.5 | 80 |
| Example 25 | 85% | 8-Methacryloxyoctyltrimethoxysilane | 318.5 | 0.5 | 80 |
| Example 26 | 100% | Vinyltrimethoxysilane | 190.3 | 0.5 | 80 |
| Example 27 | 100% | Vinyltrimethoxysilane | 190.3 | 0.5 | 80 |
| Example 28 | 100% | Vinyltrimethoxysilane | 190.3 | 0.5 | 80 |
| Example 29 | 100% | Vinyltrimethoxysilane | 190.3 | 0.5 | 80 |

It was found that the surface-treated spherical silica according to each of Examples 3 to 29 had higher peel strength and higher peel strength after high-temperature and high-humidity test than those of Comparative Examples (Examples 1 and 2), and were excellent in both adhesiveness to resin and the reliability thereof.

On the other hand, the spherical silica of Example 1 and the surface-treated spherical silica of Example 2, which were Comparative Examples, had lower peel strength and a significant decrease in the peel strength after high-temperature and high-humidity test, and thus the adhesiveness to resin and the reliability thereof were poor.

Although the present invention has been described in detail with reference to specific aspects, it is apparent to those skilled in the art that various changes and modifications can be made without departing from the spirit and scope of the present invention.

Note that the present application is based on a Japanese patent application (Japanese Patent Application No. 2023-099442) filed on Jun. 16, 2023, the entire contents of which are incorporated herein by reference.

1. Surface-treated spherical silica, having a median diameter d50 of 0.5 μm to 20 μm, a product A×d50 of a BET specific surface area A (m²/g) and the median diameter d50 (μm) being 2.7 (μm·m²/g) to 5.0 (μm·m²/g), a peak area of an amine in chromatography being 70% or more of a theoretical value, and a symmetry coefficient S of 8 or less in the chromatography.

2. The surface-treated spherical silica according to claim 1, having the BET specific surface area of 0.1 m²/g to 3.5 m²/g.

3. The surface-treated spherical silica according to claim 1, having a Ti content of 30 ppm by mass to 1500 ppm by mass.

4. A method for producing the surface-treated spherical silica according to claim 1, the method comprising:
performing a surface treatment on untreated spherical silica, wherein
a value obtained by dividing a molecular weight of a silane coupling agent used in the surface treatment by the number of Si atoms contained in one molecule of the silane coupling agent is 100 to 300.

5. The method for producing the surface-treated spherical silica according to claim 4, wherein
the surface treatment comprises bringing the untreated spherical silica into contact with the silane coupling agent, followed by heating at a temperature of 50° C. to 200° C.

6. The method for producing the surface-treated spherical silica according to claim 5, wherein
a solvent is used during the contact, and a solvent charged amount per gram of the untreated spherical silica is 0.1 ml/g to 1.0 ml/g.

7. A resin composition comprising:
the surface-treated spherical silica according to claim 1; and
a resin.
